(19) United States
(12) Patent Application Publication
(10) Pub. No.: US 2014/0030000 A1
(43) Pub. Date: Jan. 30, 2014

(54) SHEET PROCESSING APPARATUS AND IMAGE FORMING APPARATUS

(71) Applicant: CANON KABUSHIKI KAISHA, Tokyo (JP)

(72) Inventors: Yohei Gamo, Abiko-shi (JP); Hideto Abe, Toride-shi (JP); Toshiyuki Iwata, Abiko-shi (JP); Rikiya Takemasa, Kashiwa-shi (JP); Akito Sekigawa, Matsudo-shi (JP)

(21) Appl. No.: 13/946,286

(22) Filed: Jul. 19, 2013

(30) Foreign Application Priority Data
Jul. 26, 2012 (JP) 2012-166067

(51) Int. Cl. G03G 15/00

(52) U.S. Cl. CPC G03G 15/6582
USPC 399/408; 270/58.07

(57) ABSTRACT

A sheet processing apparatus that forms unevenness on a sheet bundle including a plurality of sheets to bind the sheet bundle includes: a scoring portion that scores the sheet along an edge of the sheet bundle apart from the edge of the sheet bundle at a predetermined interval; and a binding portion that forms an unevenness between the edge of the sheet bundle and the score formed on the sheet bundle by the scoring portion while the sheet bundle is nipped between a pair of tooth-like members, each of which has a concavo-convex portion that meshes with each other.

### BACKGROUND OF THE INVENTION

1. Field of the Invention

The present invention relates to a sheet processing apparatus and an image forming apparatus capable of binding a sheet bundle including a plurality of sheets without using a binding tool such as a staple.

2. Description of the Related Art

In the related art, there is known an image forming apparatus, such as a copying machine, a printer, a facsimile, and a multi-function peripheral, provided with a sheet processing apparatus that performs a binding process for binding a sheet bundle including a plurality of sheets where images are formed by the image forming apparatus. Typically, in such a sheet processing apparatus, a stapling process for binding a sheet bundle is performed using a metal staple. However, although a sheet bundle can be reliably bound in such a metal-staple-based stapling process, a work for removing a staple is necessary in order to recycle the bound sheet bundle or put the sheets into a shredder, which consumes time. In addition, since the staple is an expendable item, cost also increases accordingly.

In this regard, in consideration of environment, a sheet processing apparatus that does not use a binding tool has been proposed by focusing on recyclability. This sheet processing apparatus has a binding portion capable of binding sheets by forming an unevenness on a sheet. A sheet processing apparatus having such a configuration is disclosed in, for example, Japanese Patent Laid-Open No. 2004-155537.

The sheet processing apparatus disclosed in Japanese Patent Laid-Open No. 2004-155537 includes a pressing portion having a plurality of convex portions and a receiving portion having a plurality of concave portions. The pressing portion and the receiving portion can be engaged to each other vertically in an overlapping manner. Sheets are stacked between the pressing portion and the receiving portion while the pressing portion and the receiving portion are separated from each other. While a sheet bindle obtained by stacking a predetermined number of sheets is nipped therebetween, the pressing portion and the receiving portion are moved to approach each other, so that a uneven shape is formed in the sheet bundle by the convex portion of the pressing portion and the concave portion of the receiving portion, and the sheet bundle is bound.

However, in the sheet processing apparatus disclosed in Japanese Patent Laid-Open No. 2004-155537, a force applied to the sheet for locally deforming the shape may generate a ripple in the vicinity of the uneven shape of the sheet bundle when the uneven shape is formed in order to bind the sheets together.

### SUMMARY OF THE INVENTION

In this regard, the present invention provides a sheet processing apparatus capable of preventing a ripple generated when an uneven shape is formed in a sheet bundle from spreading to the surroundings and improving quality of a product obtained by forming the uneven shape to bind the sheets. According to an aspect of the present invention, there is provided a sheet processing apparatus that forms unevenness on a sheet bundle including a plurality of sheets to bind the sheet bundle, including: a scoring portion that scores the sheet along an edge of the sheet bundle apart from the edge of the sheet bundle at a predetermined interval; and a binding portion that forms an unevenness between an edge of the sheet bundle and the score formed on the sheet bundle by the scoring portion while the sheet bundle is nipped between a pair of tooth-like members, each of which has a concavo-convex portion that meshes with each other.

According to the present invention, in a case where the sheets are bound by forming an unevenness in the sheet bundle, propagation of a force generated in the binding process is blocked by the score so that it is possible to prevent a ripple from spreading. As a result, it is possible to improve quality of a product obtained by forming the unevenness on the sheet to bind the sheets.

Further features of the present invention will become apparent from the following description of exemplary embodiments with reference to the attached drawings.

### BRIEF DESCRIPTION OF THE DRAWINGS

FIG. 1 is a cross-sectional view illustrating an image forming apparatus and a sheet processing apparatus;

FIG. 2 is a block diagram illustrating a controller for the image forming apparatus and the sheet processing apparatus;

FIG. 3 is a cross-sectional view illustrating the sheet processing apparatus;

FIG. 4 is a schematic diagram illustrating a binding process in the sheet processing apparatus;

FIGS. 5A and 5B are schematic diagrams illustrating a binding process in the sheet processing apparatus;

FIG. 6 is a detailed view illustrating a binding unit of the sheet processing apparatus;

FIG. 7 is a detailed view illustrating a binding unit of the sheet processing apparatus;

FIG. 8 is a detailed view illustrating a binding unit of the sheet processing apparatus;

FIGS. 9A and 9B are partially detailed views illustrating the binding unit of the sheet processing apparatus;

FIGS. 10A to 10D are schematic diagrams illustrating another type of the binding process in the sheet processing apparatus;

FIG. 11 is a schematic diagram illustrating a phenomenon that may be generated in the binding process of the sheet processing apparatus;

FIG. 12 is a block diagram illustrating a binding controller of the sheet processing apparatus;

FIG. 13 is a flowchart illustrating a binding process in the sheet processing apparatus; and

FIG. 14 is a flowchart illustrating a binding process in the sheet processing apparatus.

### DESCRIPTION OF THE EMBODIMENTS

Exemplary embodiments of the invention will now be described in detail with reference to the accompanying drawings. In the following description of the embodiments, it would be appreciated that dimensions, materials, shapes, relative arrangements, and the like of components may be appropriately changed depending on a configuration of the apparatus according to the invention or various conditions. Thus, unless specified otherwise, such a description is not intended to limit the scope of the invention.

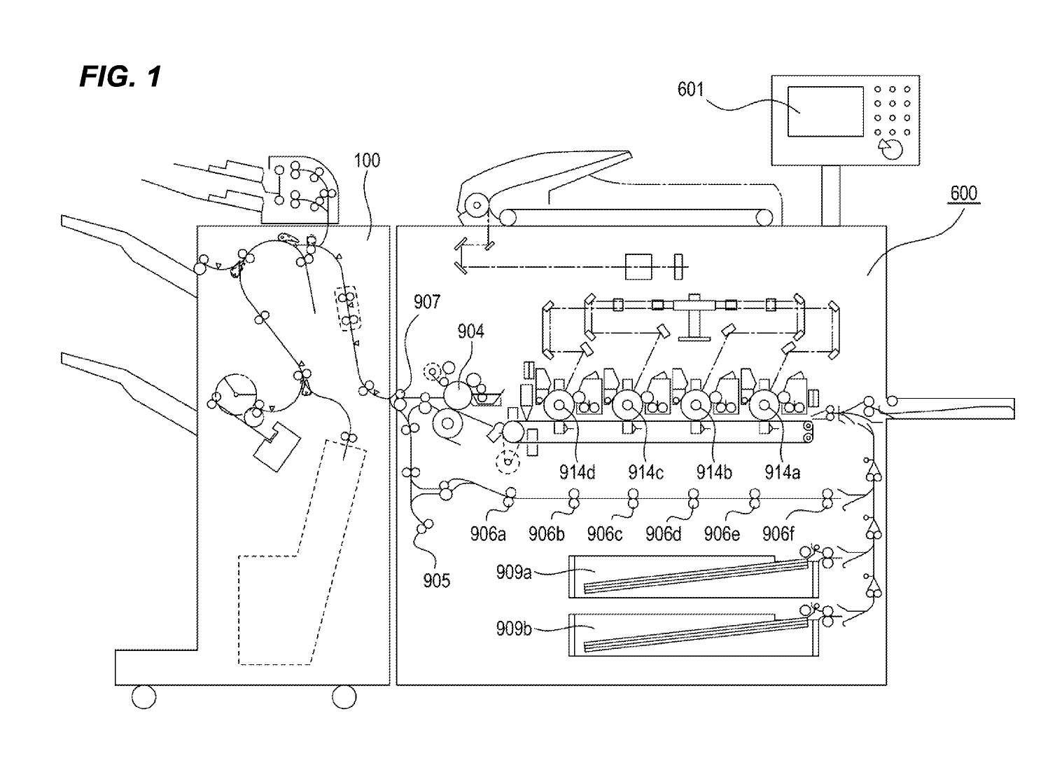

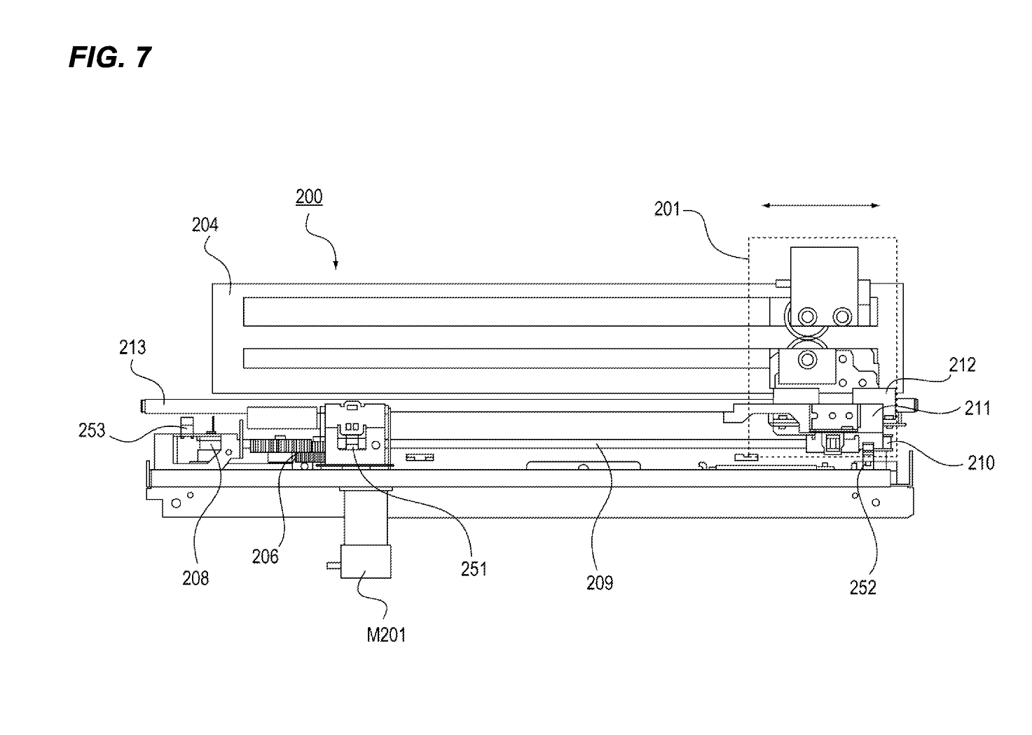

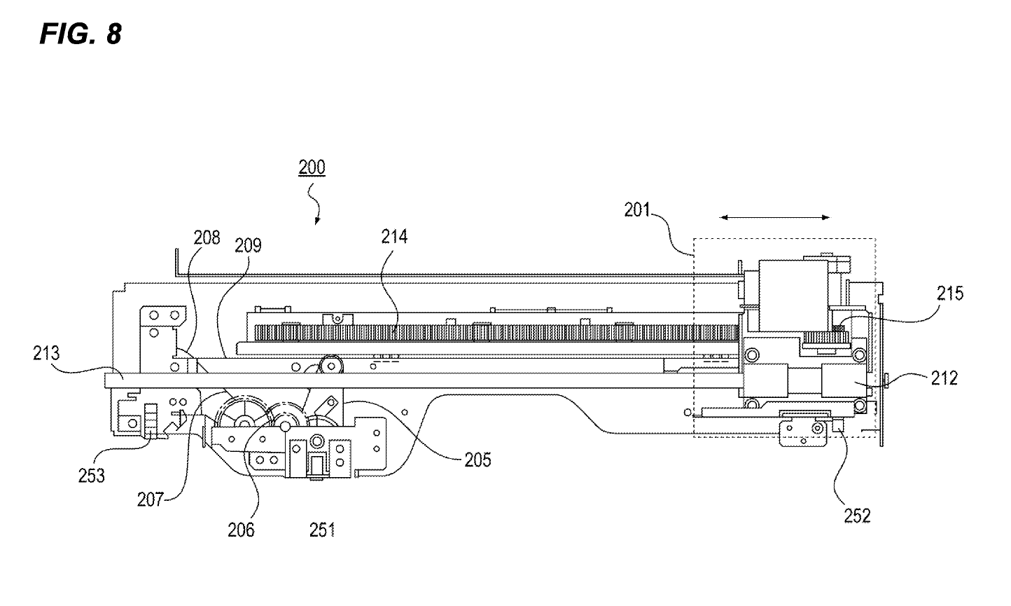

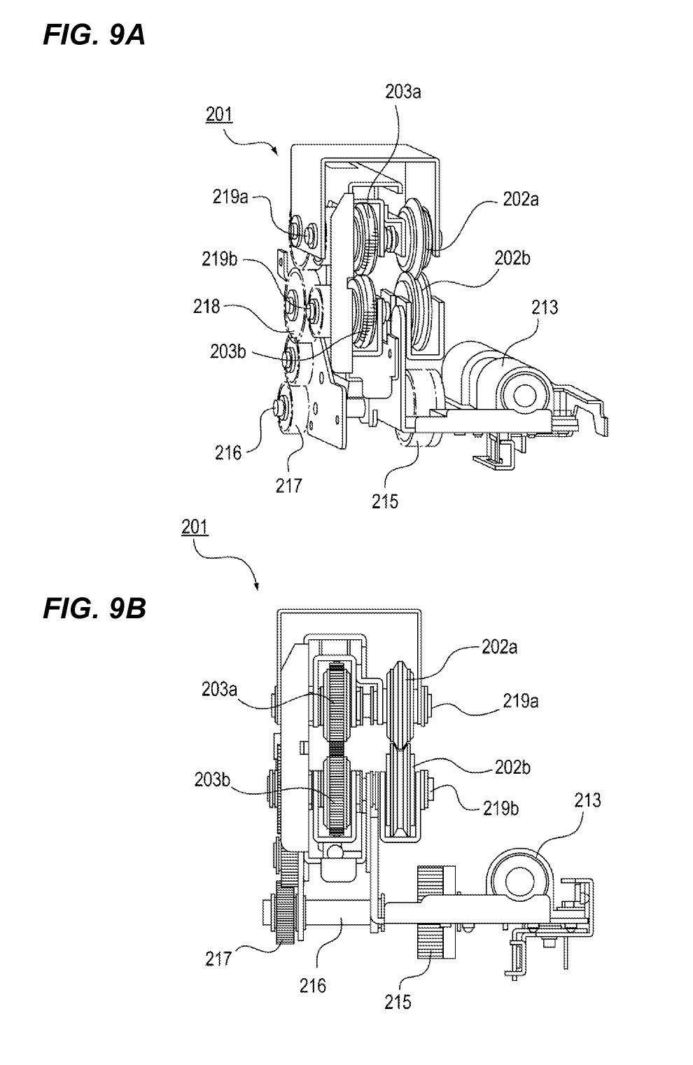

Hereinafter, a sheet processing apparatus and an image forming apparatus having the sheet processing apparatus according to an embodiment of the invention will be described with reference to FIGS. 1 to 10. In the following description, numerical values are just for reference and are not intended to limit the invention. Further, like reference numerals denote like elements, and descriptions thereof will not be repeated.

<Image Forming Apparatus> FIG. 1 is a schematic diagram illustrating the image forming apparatus and the sheet processing apparatus. As illustrated in FIG. 1, the image forming apparatus includes an image forming apparatus main unit 600 that forms a monochrome/color image and a finisher 100 as a sheet processing apparatus connected thereto. For this reason, the sheet discharged from the image forming apparatus main unit 600 can be processed by the finisher 100 connected in an on-line manner.

Here, since a user performs various input/setup operations for the image forming apparatus main unit 600, a location facing an operation portion 601 is set to a front side (hereinafter, referred to as a near side) of the image forming apparatus, and a rear side of the apparatus opposite to the front side will be referred to as a far side. FIG. 1 illustrates a configuration of the image forming apparatus as seen from the near side of the apparatus. The finisher 100 is connected to a lateral side in the sheet discharge port side of the image forming apparatus main unit 600.

Onto the sheet supplied from the cassette 909a or 909b of the image forming apparatus main unit 600, a four-color toner image is transferred using yellow, magenta, cyan, black photosensitive drums 914a to 914d serving as an image forming unit. Then, the sheet is conveyed to a fixing device 904 to fix the toner image. In a single-side image forming mode, the sheet is directly discharged to the outside from the discharge roller pair 907.

In a double-side image forming mode, the sheet is delivered to a reversing roller 905 from the fixing device 904, and the front and back sides of the sheet are reversed. Then, the sheet is conveyed to the double-sided conveying rollers 906a to 906f. A four-color toner image is transferred again to the back side using the yellow, magenta, cyan, and black photosensitive drums 914a to 914d. The sheet having images transferred to both sides is conveyed again to the fixing device 904 to fix the toner image. Then, the sheet is discharged to the outside from the discharge roller pair 907.

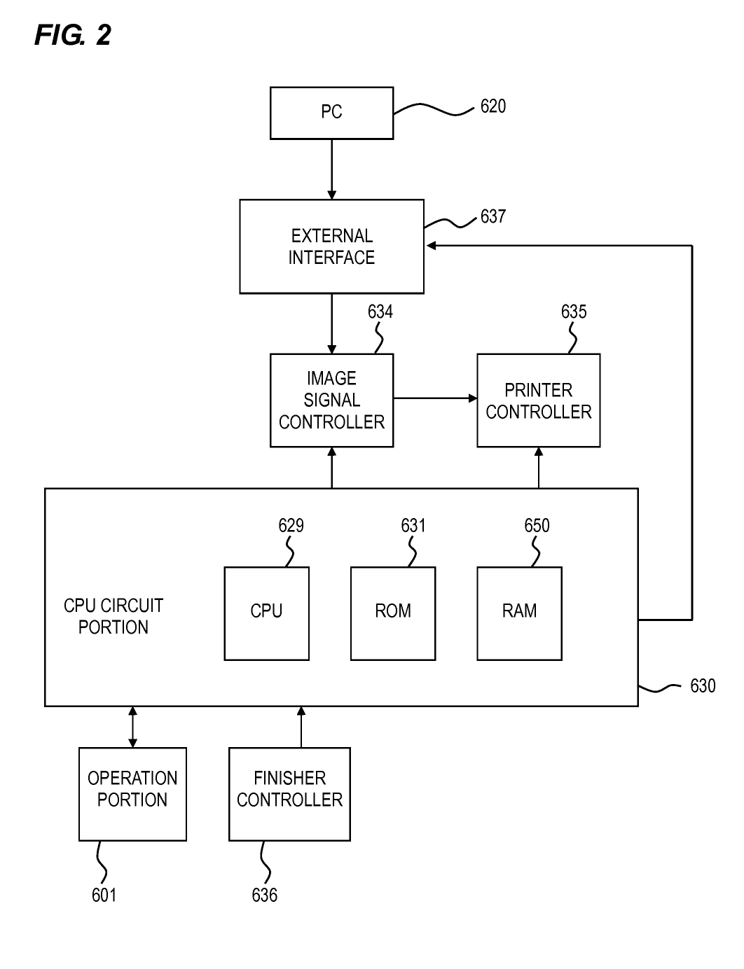

FIG. 2 is a block diagram illustrating a controller that controls the image forming apparatus and the sheet processing apparatus. As illustrated in FIG. 2, the CPU circuit portion 630 includes a central processing unit (CPU) 629, a read-only memory (ROM) 631, and a random access memory (RAM) 650. The CPU circuit portion 630 controls an image signal controller 634, a printer controller 635, a finisher controller 636, and an external interface 637. The CPU circuit portion 630 performs control based on a program stored in the ROM 631 and a setting of an operation portion 601. The printer controller 635 controls the image forming apparatus main unit 600. The finisher controller 636 controls the finisher 100.

Here, a configuration of the finisher controller (controller) 636 mounted on the finisher 100 will be described. However, the invention is not limited thereto. Instead, the finisher controller 636 may be provided in the image forming apparatus main unit 600 integrally with the CPU circuit portion 630 so that the finisher 100 can be controlled from the image forming apparatus main unit 600 side.

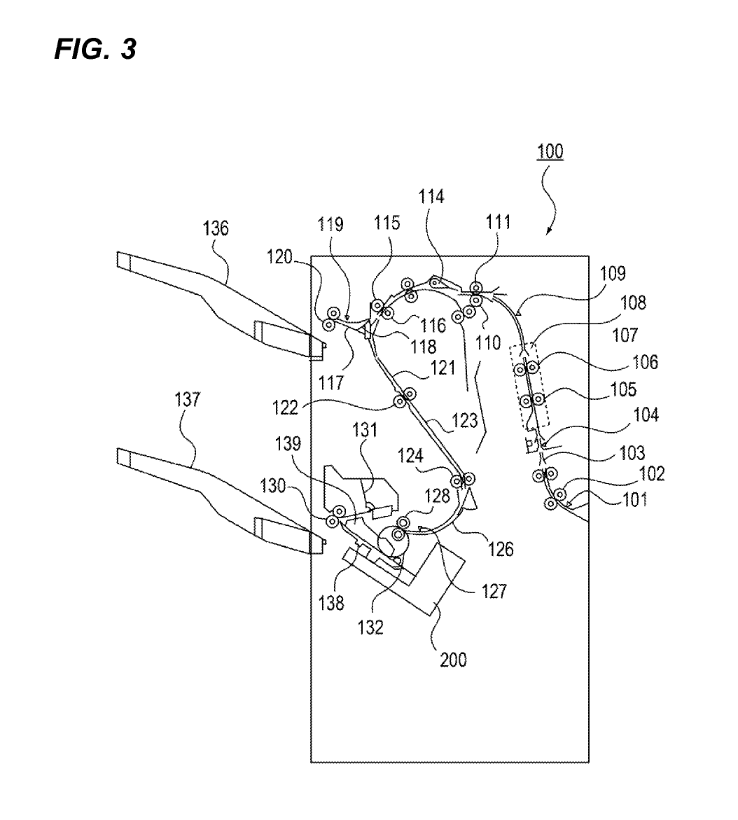

The RAM 650 is used as an area for temporarily storing control data or a work area for operations generated in control. An external interface 637 as an interface from the computer (PC) 620 applies print data to an image and outputs the image to the image signal controller 634. The image output from the image signal controller 634 to the printer controller 635 is input to an exposure controlling portion.

<Sheet Processing Apparatus> An overview of the finisher 100 as a sheet processing apparatus will be described with reference to FIG. 3.

As illustrated in FIG. 3, the finisher 100 has a staple-less binding unit 200 as a sheet binding unit that scores a sheet bundle and applies a binding process to a lateral side of the score. The staple-less binding unit 200 will be described in more detail below.

The sheet discharged from the image forming apparatus main unit 600 is delivered to an entrance roller pair 102 of the finisher 100. In this case, a sheet delivery timing is also detected by an entrance sensor 101 at the same time. While the sheet conveyed by the entrance roller pair 102 passes through the conveyance path 103, an edge position in a width direction perpendicular to the sheet-conveying direction is detected by the edge detection sensor 104. As a result, it is detected whether or not there is any error (positional deviation) in the width direction with respect to a center position of the finisher in the width direction.

Then, a shift operation of the sheet in the width direction is performed by moving the shift unit 108 by a predetermined distance in a near-far direction (width direction of the sheet) based on the detected deviation in the width direction while the sheet is conveyed by the shift roller pairs 105 and 106. That is, the positional deviation of the sheet in the width direction is corrected by moving the finisher 100 by a predetermined distance in the width direction of the sheet.

Then, the sheet is delivered to a conveying roller 110 and a separating roller 111. In this case, a timing for delivering the sheet to the conveying roller 110 is detected by a buffer sensor 109. The sheet conveyed by the conveying roller 110 and the separating roller 111 is conveyed by a buffer roller pair 115. Then, in a case where the sheet is discharged to an upper discharge tray 136, an upper path switching member 118 is driven by a driving portion such as a solenoid (not illustrated) to guide the sheet to an upper discharge path 117 and discharge the sheet to the upper discharge tray 136 using an upper discharge roller 120.

In a case where the conveyed sheet is discharged to a lower discharge tray 137, the sheet conveyed by the buffer roller pair 115 is guided to a bundle conveyance path 121 by the upper path switching member 118. Then, the sheet passes through the bundle conveyance path 123 by the buffer roller pair 122 and the bundle conveying roller pair 124 and is delivered to the bundle conveying roller pair 124. In addition, the sheet is conveyed to a lower discharge path 126 by the bundle conveying roller pair 124. Then, the sheet is discharged to the intermediate processing tray 138 by the lower discharge roller pair 128 as a sheet conveying portion. In this case, the discharge sensor 127 detects a timing of discharging the sheet to an intermediate processing tray 138.

For the sheet discharged to the intermediate processing tray 138 as a sheet stacking portion, an alignment process for aligning a sheet edge in a conveyance direction is performed by driving an alignment paddle 131 and a knurling belt 132 based on the discharge timing detected by the discharge sensor 127. Similarly, an alignment process for aligning a sheet edge in the width direction is performed by driving an aligning plate 139 based on the discharge timing detected by the discharge sensor 127. The sheet is temporarily stacked on the intermediate processing tray 138.

In a case where the binding process is applied to the sheet stacked on the intermediate processing tray 138, the staple-less binding unit 200 as a sheet binding unit scores the sheet bundle, and a binding process is applied to a lateral side of the score after a predetermined amount of sheets are stacked. As the binding process is terminated, the sheet bundle is discharged to the lower discharge tray 137 by the bundle discharge roller pair 130. The staple-less binding unit 200 will be described in more detail below.

In a case where the binding process is not applied to the sheet stacked on the intermediate processing tray 138, an alignment process in the width direction is performed for the sheet shifted and conveyed by the shift unit 108 in a near-far direction using the aligning plate 139. A predetermined amount of sheets are stacked on the intermediate processing tray 138 and are discharged to the lower discharge tray 137 by the bundle discharge roller pair 130. The sheet is sorted and stacked on the lower discharge tray 137.

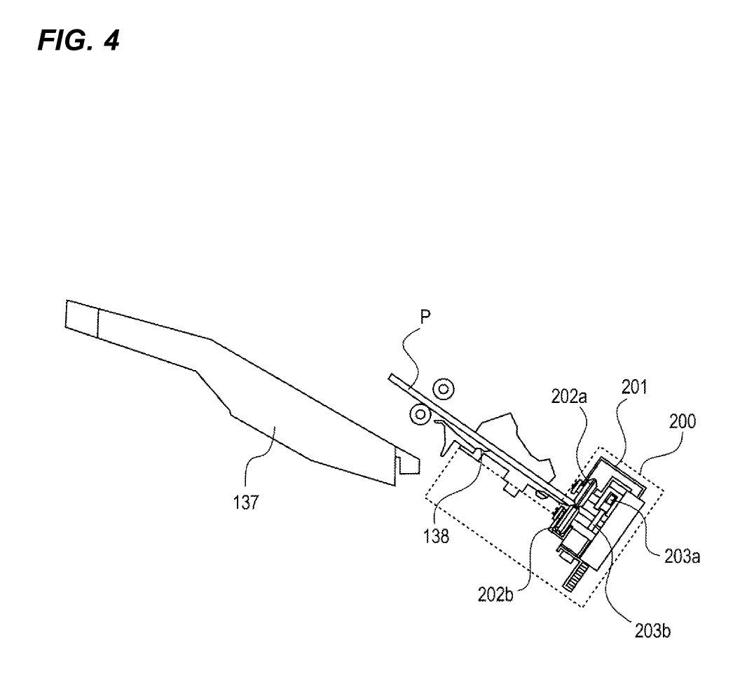

(Staple-less Binding Unit) Next, a description will be made for a configuration and effects of the staple-less binding unit 200 as a main part of the present embodiment with reference to FIGS. 4 to 8.

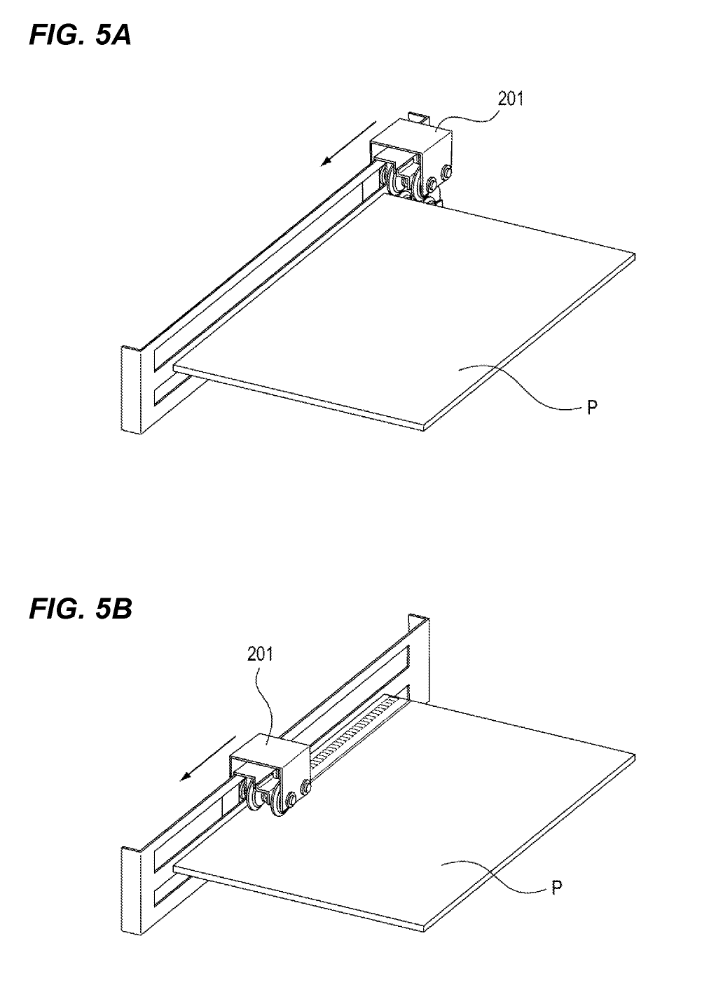

First, as illustrated in FIG. 4, the staple-less binding unit 200 has a binding process unit 201 located in the vicinity of a rear edge of the sheet P stacked on the intermediate processing tray 138 and capable of moving in a near-far direction (width direction perpendicular to the sheet-conveying direction). As illustrated in FIGS. 5A and 5B, the staple-less binding unit 200 scores the stacked sheet (sheet bundle) P by moving the binding process unit 201 and forms an uneven shape in a lateral side of the score to bind the sheet bundle.

The binding process unit 201 includes scoring rollers 202a and 202b as a scoring portion that scores the sheet and a binding portion having a pair of binding rollers 203a and 203b as a tooth-like member that forms unevenness on the sheet in the thickness direction to bind the sheet bundle. The scoring roller 202 and the binding roller 203 rotationally move in synchronization with a movement of the binding process unit 201 along the sheet edge.

The scoring roller 202 includes a scoring roller 202b as a concave rotating member having a hollow (concave portion) and a scoring roller 202a as a convex rotating member having a convex portion engaged with the hollow. Using the scoring roller 202, the sheet bundle is corrugated to match the uneven shape of the scoring roller 202 while the sheet bundle is nipped between the rollers. The scoring roller 202 rotationally moves on the sheet bundle, and each roller is rotated to engage the convex portion and the concave portion while the sheet bundle is nipped between the rollers to score the sheet bundle. As illustrated in FIG. 5B, the scoring roller 202 scores the sheet bundle P along an edge of the sheet bundle P at a predetermined interval from the edge of the sheet bundle.

The binding roller 203 is a pair of rotating members having a binding roller 203b as a first rotating member having a concavo-convex portion in an outer circumferential surface and a binding roller 203a as a second rotating member having a concavo-convex portion engaged with the concavo-convex portion of the binding roller 203b in an outer circumferential surface. That is, the binding roller 203 as a pair of rotating members is a gear-type roller pair having an uneven surface. As illustrated in FIG. 5B, the binding roller 203 forms an unevenness on the sheet bundle P in a thickness direction between the score formed by the scoring roller 202 and the edge of the sheet bundle. Similar to the scoring roller 202, the binding roller 203 as a pair of rotating members nips the sheet bundle so that the sheet bundle is corrugated to match the uneven shape of the binding roller 203. The binding roller 203 rotationally moves on the sheet bundle to form an unevenness on the sheet bundle while the sheet bundle is nipped between the rollers such that the concavo-convex portions of a pair of the binding rollers mesh with each other. The sheet bundle including a plurality of sheets are bound by entangling fibers of the sheet using the uneven shape formed on the sheet as described above.

Although the scoring and the binding are simultaneously performed for the sheet bundle according to the present embodiment, the invention is not limited thereto. For example, if productivity is allowable, the binding may be performed after the scoring of the sheet bundle. Similarly, although the sheet bundle is scored according to the present embodiment, the invention is not limited thereto. For example, the scoring may be performed for every single sheet, and the scored sheets may be overlappingly bound. Although the binding is performed by rotationally moving the movable binding roller with respect to the sheet according to the present embodiment, the invention is not limited thereto. The binding may be performed by relatively moving the binding roller and the sheet.

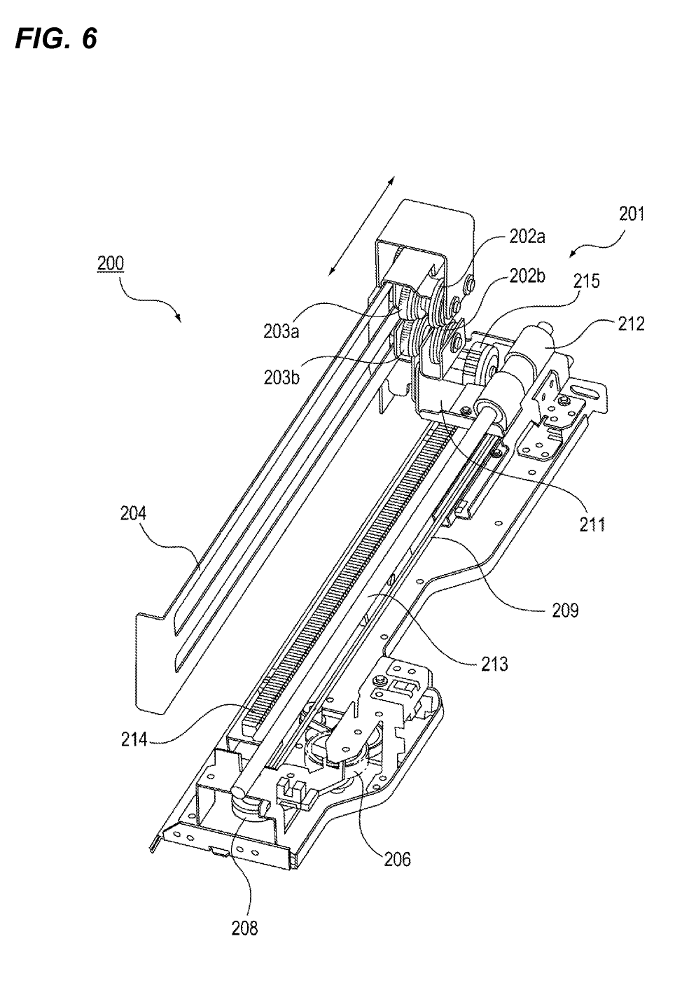

Next, a configuration for moving the staple-less binding unit 200 will be described with reference to FIGS. 6, 7, 8, 9A, and 9B. The staple-less binding unit 200 has a binding process motor M201 as a driving source, and a revolution number of the binding process motor M201 is monitored by a binding process sensor 251. A timing belt 205 is looped over the binding process motor M201 so that a driving force is transmitted to a series of gears 206, to a timing belt 207, to a pulley 208, to a timing belt 209, and to a pulley 210. A base plate 211 of the binding process unit is installed in the timing belt 209. The binding process unit 201 is installed in the base plate 211 of the binding process unit. In addition, a shaft holder 212 is fixed to the binding process unit base plate 211, and the shaft holder 212 is movably held in an axial direction with respect to a slide shaft 213. Therefore, as the binding process motor M201 is driven, the driving force is transmitted to the timing belt 209, so that the binding process unit 201 moves in a near-far direction along the slide shaft 213 through the shaft holder 212 and the binding process unit base plate 211. That is, the binding process unit 201 moves in the width direction (near-far direction) perpendicular to the sheet-conveying direction while each roller is rotated as described below.

Each edge in the near-far direction within the movable range of the binding process unit 201 is provided with binding process unit home position (HP) sensors 252 and 253 in order to monitor the home position of the binding process unit 201 provided in the near and far sides. A rack gear 214 is provided under the binding process unit base plate 211, and a longitudinal direction of the rack gear 214 is parallel to a longitudinal direction (near-far direction) of the slide shaft 213. The shaft 216 for holding a pinion gear 215 meshing with the rack gear 214 is rotatably held by the binding process unit base plate 211. For this reason, as the binding process unit base plate 211 rectilinearly moves in the near-far direction, the shaft 216 is rotated by the pinion gear 215 meshing with the rack gear 214.

A gear 217 is further installed in the shaft 216. In addition, rotation of the shaft 216 is transmitted to a shaft 219a that holds the scoring roller 202a and the binding roller 203a and a shaft 219b that holds the scoring roller 202b and the binding roller 203b through a series of gears 218 connected to the gear 217. Therefore, the scoring roller 202 and the binding roller 203 rotationally move along with the rectilinear movement of the binding process unit 201 in the near-far direction. The gear ratio between each gear is set such that the moving velocity of the binding process unit 201 and the circumferential velocities of the scoring roller 202 and the binding roller 203 are synchronized at a circumferential velocity.

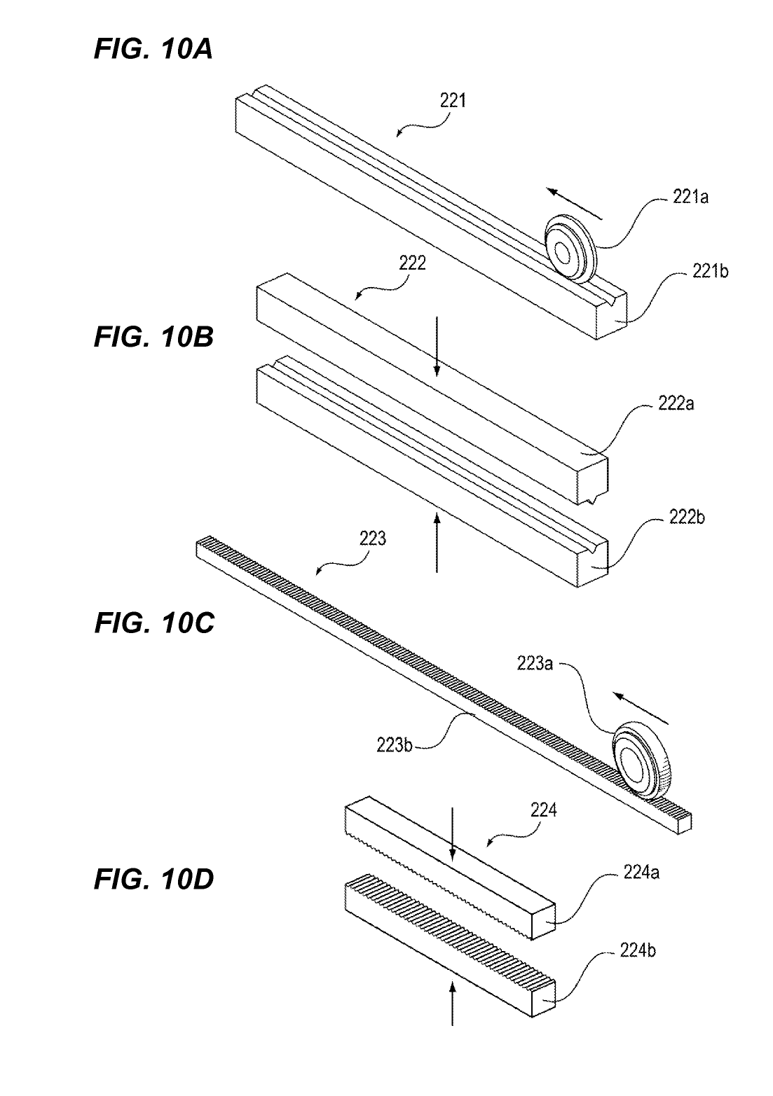

In this configuration, it is possible to bind the sheet bundle by scoring the sheet and forming an uneven shape in a lateral side of the score. In addition, although the sheet or the sheet bundle is scored by engaging a rotating member having a hollow and a rotating member having a convex portion, as a scoring unit, and rotationally transferring the uneven shape according to the present embodiment, the invention is not limited thereto. For example, the configuration may be made as illustrated in FIGS. 10A to 10D.

As illustrated in FIG. 10A, it may be conceivable that any one of the scoring component having the hollow (concave portion) and the scoring component having the convex portion may have a rail-like shape, so that the scoring may be performed by causing the rotating member to rotationally scan the rail. FIG. 10A illustrates a configuration in which the hollow has a rail-like shape. Specifically, the scoring portion 221 illustrated in FIG. 10A includes a scoring roller 221a as a rotating member having a convex portion (or concave portion) in an outer circumferential surface and a scoring rail 221b having a concave portion (or convex portion) that guides the movement of the scoring roller 221a. The scoring rail 221b meshes with the convex portion (concave portion) of the scoring roller 221a, and the scoring roller 221a moves along the scoring rail 221b so as to score the sheet.

Alternatively, as illustrated in FIG. 10B, it may be conceivable that a concave scoring member having a hollow (concave portion) extending in the scoring direction and a convex scoring member having a convex portion are provided such that the hollow and the convex portion face each other and can move in a joining/disjoining direction. In this configuration, the hollow and the convex portion are pressed to each other in an engagement position, so that the sheet can be scored without rotational scanning. That is, the scoring portion 222 of FIG. 10B includes a receiving member 222b as a concave scoring member having a concave portion (hollow) and a pressing member 222a as a convex scoring member having a convex portion engaging with the concave portion of the receiving member 222b. In addition, the sheet bundle is scored by causing the convex portion of the pressing member 222a and the concave portion of the receiving member 222b to approach each other while the sheet bundle is nipped between the pressing member 222a and the receiving member 222b. The invention is not limited thereto, at least one of the pressing member 222a and the receiving member 222b may be able to move.

Alternatively, as illustrated in FIG. 10C, it may be conceivable that, out of a pair of tooth-like members 223 having the binding portion, one of the tooth-like members 223 is used as a rotating member 223a having a concavo-convex portion in an outer circumferential surface, and the other tooth-like member 223 is used as a rail 223b having a guide portion for guiding movement of the rotating member 223a. On the guide portion, a concavo-convex portion meshing with the concavo-convex portion of the rotating member 223a is formed. An unevenness is formed on the sheet bundle by moving the rotating member 223a along the guide portion of the rail 223b while the sheet bundle is nipped such that the concavo-convex portion of the rotating member 22a and the concavo-convex portion of the rail 223b mesh with each other.

Alternatively, as illustrated in FIG. 10D, it may be conceivable that a pair of tooth-like members provided in the binding portion includes a first tooth-like member 224a having a concavo-convex portion extending in the binding direction on a surface and a second tooth-like member 224b having a concavo-convex portion extending in the binding direction. Such a pair of tooth-like members are provided such that the concavo-convex portions are arranged to mesh with each other and are movable in the joining/disjoining direction. In addition, an uneven shape is formed on the sheet bundle to perform binding by causing a pair of the tooth-like members 224a and 224b to approach each other such that the concavo-convex portions to mesh with each other while the sheet bundle is nipped between the pair of the tooth-like members 224a and 224b. The invention is not limited thereto, at least one of the pair of the tooth-like members 224a and 224b may be able to move.

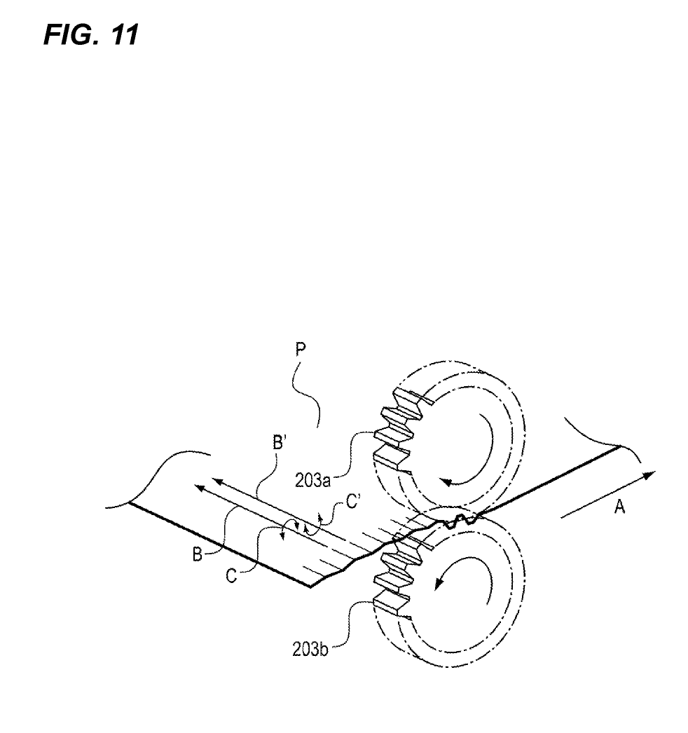

Next, a description will be made for effects of forming the score in a lateral side of the binding portion when the binding is performed by forming the uneven shape on the sheet with reference to FIG. 11. It is necessary to locally deform a shape of the sheet in order to binding the sheet by forming an uneven shape on the sheet using the binding rollers 203a and 203b. For this reason, a local bending stress is applied to the sheet. In the case of the uneven shape of the present embodiment, bending in the arrow direction C and bending in the arrow direction C′ in FIG. 11 are alternately applied with a small pitch along the arrow direction A corresponding to the binding direction. Such a bending stress propagates to a direction (arrow directions B and B′) perpendicular to the binding direction and generates a ripple. Meanwhile, the score parallel to the binding direction has a cross-sectional shape that reinforces a bending stiffness with respect to the direction of the bending stress generated by forming the uneven shape to bind the sheet. Therefore, by performing the binding process in the vicinity of the score, it is possible to prevent a ripple caused by the bending stress generated in the binding process from being generated in the scoring portion and prevent the ripple from spreading since the score blocks propagation of the previous bending stress.

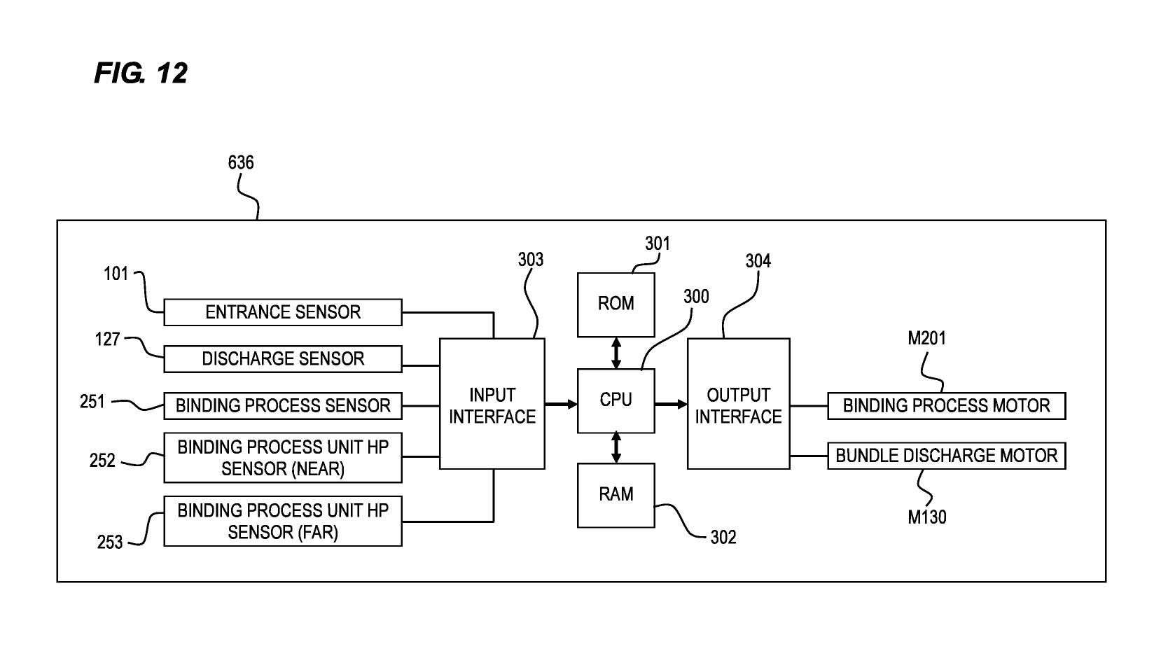

Next, an operation of the binding process will be described with reference to FIGS. 12, 13, and 14.

FIG. 12 is a functional block diagram illustrating a controller (finisher controller 636) in the finisher 100 as a sheet processing apparatus.

The finisher controller 636 as a controller is configured as a microcomputer system and includes a CPU 300, a ROM 301, a RAM 302, and the like. The ROM 301 stores a program for a stitching process, a binding process, or the like in advance. The CPU 300 executes each program and appropriately exchanges data with the RAM 302 to process the input data and generate a predetermined control signal. In addition, data is transmitted/received between the CPU 300 and the main unit CPU 630 provided in the image forming apparatus main unit 600 side, so that the CPU 300 obtains various types of information such as an original size or a copy number from the main unit CPU 630.

The finisher controller 636 includes detecting portion such as an entrance sensor 101, a discharge sensor 127, a binding process sensor 251, a binding process unit HP sensor (near) 252, and a binding process unit HP sensor (far) 253. A detection signal obtained from such detecting portion is input to the CPU 300 through the input interface 303 as input data. Various control signals from the CPU 300 are output through the output interface 304. The output signal is transmitted to a control device such as a motor driver and is used to actuate the binding process motor M201, the bundle discharge motor M130 that drives the bundle discharge roller, or the like using the control device.

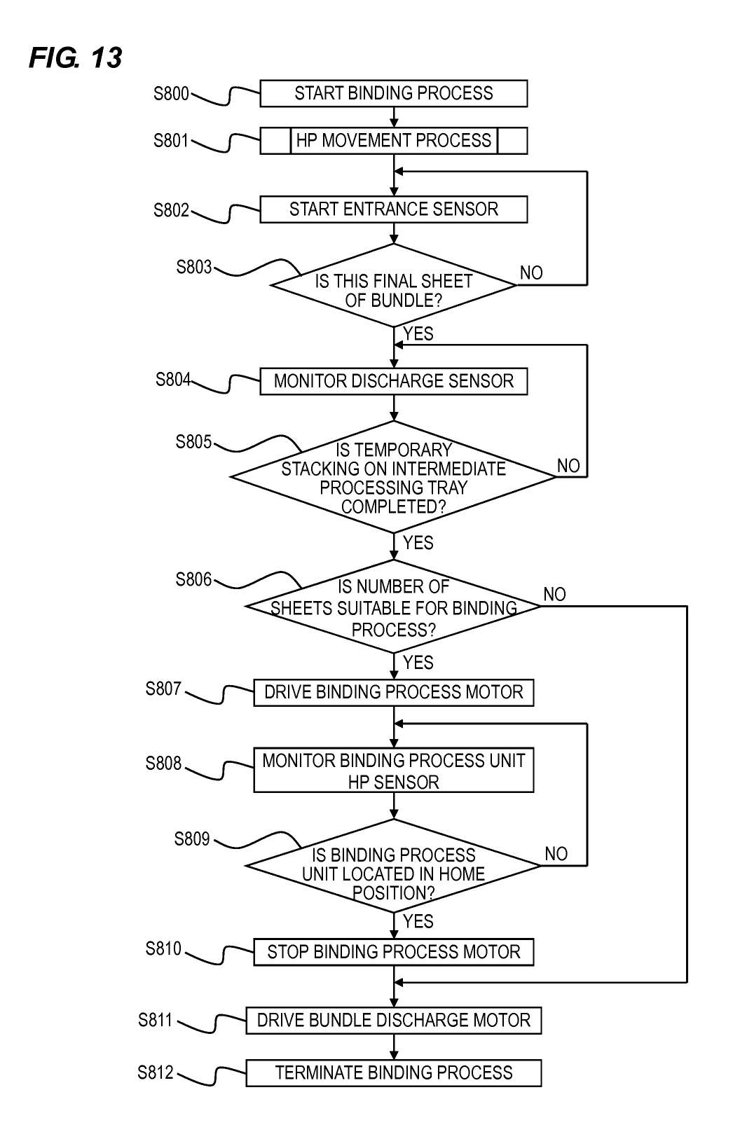

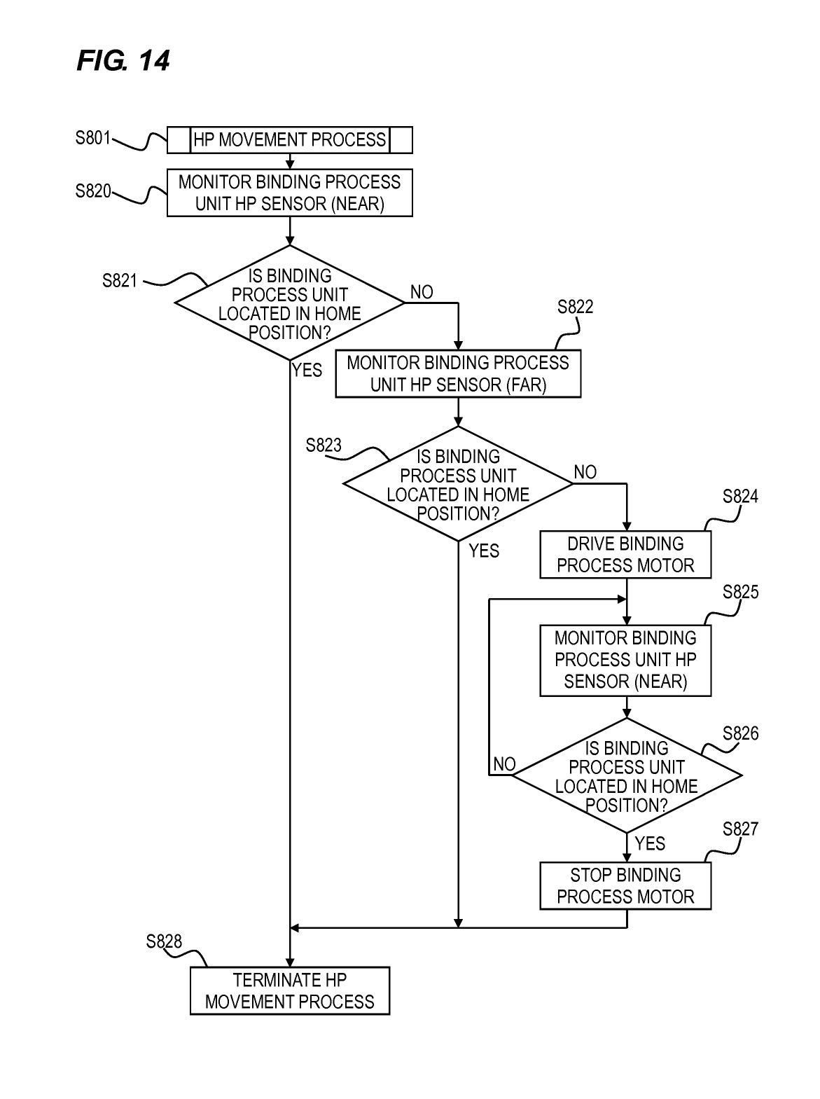

FIGS. 13 and 14 are flowcharts illustrating an operation of the binding process. If the binding process is selected, first, an HP movement process is performed (S800 and S801).

As illustrated in FIG. 14, in the HP movement process, first, the binding process unit HP sensor (near) 252 is monitored to determine whether or not the binding process unit 201 is located in a home position in the near side (S820 and S821). If it is determined that the binding process unit 201 is located in the home position in the near side, the HP movement process is terminated since the binding process unit 201 is located in the home position in the near side (S828). If it is determined that the binding process unit 201 is not located in the home position in the near side, then the binding process unit HP sensor (far) 253 is monitored to determine whether or not the binding process unit 201 is located in the home position in the far side (S822 and S823). If it is determined that the binding process unit 201 is located in the home position in the far side, the HP movement process is terminated since the binding process unit 201 is located in the home position in the far side (S828).

Meanwhile, if it is determined, in step S823, that the binding process unit 201 is not located in the home position in the far side, the binding process motor M201 is driven to move the binding process unit 201 to the home position in the near side (S824). After the binding process motor M201 starts to drive, the binding process unit HP sensor (near) 252 is monitored to determine whether or not the binding process unit 201 reaches the home position in the near side (S825 and S826). If the HP sensor (near) 252 of the binding process unit detects that the binding process unit 201 reaches the home position in the near side, the binding process motor M201 stops, and the HP movement process is terminated (S828).

Then, as illustrated in FIG. 13, the entrance sensor 101 is continuously monitored while the conveyed sheets are counted until the final sheet of the bundle (S802 and S803). As the entrance sensor 101 detects the final sheet of the bundle, the discharge sensor 127 is monitored until the final sheet is completely discharged to the intermediate processing tray 138 (S804 and S805). Here, based on information on the number of sheets in the bundle counted in step S802, it is determined whether or not the number of sheets in the sheet bundle stacked on the intermediate processing tray 138 reaches the number of sheets suitable for the binding process (S806).

If the number of sheets in the sheet bundle stacked on the intermediate processing tray 138 is the number of sheets suitable for the binding process, the binding process motor M201 is driven to the home position in the side where the binding process unit 201 is not currently located from the home position in the near or far side recognized as a position where the binding process unit 201 is located in step S801 (S807). After the binding process motor M201 starts to drive, the binding process unit HP sensor in the side where the binding process unit 201 is not currently located is monitored. If it is determined that the binding process unit 201 reaches the home position, the binding process motor M201 stops (S808 to S810). Finally, the bundle discharge motor M130 is driven to discharge the bound sheet bundle to the lower discharge tray 137, and the binding process is terminated (S811 and S812).

If it is determined in step S806 that the number of sheets in the sheet bundle stacked on the intermediate processing tray 138 is not the number of sheets suitable for the binding process, the process advances to step S811 for discharging the bundle without performing the binding process. The sheet is discharged to the lower discharge tray 137 without performing the binding process, and the binding process is terminated (S811 and S812).

As described above, according to the present embodiment, an uneven shape is formed along the score in a lateral side of the score in the vicinity of the sheet edge to bind the sheet. Therefore, propagation of the bending stress generated by the binding process is blocked by the score so that it is possible to prevent generation of a ripple. As a result, it is possible to improve quality of a product obtained by forming the uneven shape on the sheet to bind the sheet.

Although a copying machine as the image forming apparatus has been described, the invention is not limited thereto. For example, the invention may also be applied to other types of image forming apparatuses such as a printer, a facsimile, or a multi-function peripheral obtained by combining such functionalities. It is possible to obtain similar effects to those described above by applying the invention to the sheet processing apparatus used in such types of image forming apparatuses.

Although a description has been exemplarily made for a sheet processing apparatus connected to the side portion of the main unit of the image forming apparatus in the aforementioned embodiment, the invention is not limited thereto. The sheet processing apparatus may be included in anywhere in the image forming apparatus. If the invention is applied to such a sheet processing apparatus, it is possible to obtain similar effects. In addition, a description has been made by exemplifying an operation portion provided in an image forming apparatus as an input portion for inputting information on the sheet. However, if the sheet processing apparatus is a separate part, the information of the sheet may be input from an operation portion provided in the sheet processing apparatus. Alternatively, the information on the sheet may be input from an external device such as a host computer connected to the image forming apparatus.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2012-166067, filed Jul. 26, 2012, which is hereby incorporated by reference herein in its entirety.

What is claimed is:

1. A sheet processing apparatus that forms unevenness on a sheet bundle including a plurality of sheets to bind the sheet bundle, comprising:
a scoring portion that scores the sheet along an edge of the sheet bundle apart from the edge of the sheet bundle at a predetermined interval; and
a binding portion that forms an unevenness between the edge of the sheet bundle and the score formed on the sheet bundle by the scoring portion while the sheet bundle is nipped between a pair of tooth-like members, each of which has a concavo-convex portion that meshes with each other.

2. The sheet processing apparatus according to claim 1, wherein the pair of the tooth-like members are a pair of rotating members including a first rotating member having a concavo-convex portion in an outer circumferential surface and a second rotating member having a concavo-convex portion, in an outer circumferential surface, meshing with the concavo-convex portion of the first rotating member, and
the unevenness is formed on the sheet bundle by relatively moving the pair of the rotating members and the sheet bundle while the sheet bundle is nipped between the pair of the rotating members such that the concavo-convex portions of the rotating members mesh with each other.

3. The sheet processing apparatus according to claim 1, wherein the pair of the tooth-like members includes a rotating member having a concavo-convex portion in an outer circumferential surface and a rail having a guide portion on which a concavo-convex portion meshing with the concavo-convex portion of the rotating member is formed to guide movement of the rotating member, and
the unevenness is formed on the sheet bundle by the movement of the rotating member along the guide portion of the rail while the sheet bundle is nipped between the rotating member and the rail, and the concavo-convex portion of the rotating member meshes with the concavo-convex portion of the rail.

4. The sheet processing apparatus according to claim 1, wherein the pair of the tooth-like members includes a first tooth-like member having a concavo-convex portion and a second tooth-like member having a concavo-convex portion meshing with the concavo-convex portion of the first tooth-like member,
the pair of the tooth-like members are arranged such that the concavo-convex portions mesh with each other and at least one of the pair of the tooth-like members is movable along a contact/separation direction of the concavo-convex portions, and
the unevenness is formed on the sheet bundle to bind the sheets by movement of at least one of the pair of the tooth-like members to approach each other while the sheet bundle is nipped such that the concavo-convex portions of the pair of the tooth-like members mesh with each other.

5. The sheet processing apparatus according to claim 1, wherein the scoring portion includes a concave rotating member having a concave portion and a convex rotating member having a convex portion meshing with the concave portion of the concave rotating member, and
the sheet bundle is scored by engaging and rotating the convex portion of the convex rotating member and the concave portion of the concave rotating member while the sheet bundle is nipped between the concave rotating member and the convex rotating member.

6. The sheet processing apparatus according to claim 1, wherein the scoring portion includes a concave scoring member having a concave portion and a convex scoring member having a convex portion engaged with the concave portion of the concave scoring member, and
the sheet bundle is scored by movement of at least one of the convex portion of the convex scoring member and the concave portion of the concave scoring member to approach each other while the sheet bundle is nipped between the convex scoring member and the concave scoring member.

7. The sheet processing apparatus according to claim 1, further comprising:
a sheet conveying portion that conveys the sheet; and
a sheet stacking portion that stacks the sheet conveyed by the sheet conveying portion,
wherein the scoring portion and the binding portion are configured to form a score and an unevenness in the sheet bundle stacked on the sheet stacking portion.

8. The sheet processing apparatus according to claim 1, further comprising:
a sheet conveying portion that conveys the sheet; and
a sheet stacking portion that stacks the sheet conveyed by the sheet conveying portion,
wherein the pair of the tooth-like members are a pair of rotating members including a first rotating member having a concavo-convex portion in an outer circumferential surface and a second rotating member having a concavo-convex portion meshing with the concavo-convex portion of the first rotating member in an outer circumferential surface, and
the scoring portion includes a concave rotating member having a concave portion and a convex rotating member having a convex portion engaged with the concave portion of the concave rotating member, and
the scoring portion and the pair of the tooth-like members move in synchronization with each other along an edge of the sheet bundle stacked on the sheet stacking portion to form a score and an unevenness in the sheet bundle.

9. An image forming apparatus comprising:
an image forming unit that forms an image on a sheet; and
a sheet processing apparatus that forms unevenness on a sheet bundle including a plurality of sheets having an image thereon to bind the sheet bundle,
the sheet processing apparatus having:
a scoring portion that scores the sheet along an edge of the sheet bundle apart from an edge of the sheet bundle at a predetermined interval, and
a binding portion that forms an unevenness between the edge of the sheet bundle and the score formed on the sheet bundle by the scoring portion while the sheet bundle is nipped between a pair of tooth-like members, each of which has a concavo-convex portion.

10. The image forming apparatus according to claim 9, wherein the pair of the tooth-like members are a pair of rotating members including a first rotating member having a concavo-convex portion in an outer circumferential surface and a second rotating member having a concavo-convex portion, in an outer circumferential surface, meshing with the concavo-convex portion of the first rotating member, and
the unevenness is formed in the sheet bundle by relatively moving the pair of the rotating members and the sheet bundle while the sheet bundle is nipped between the pair of the rotating members such that the concavo-convex portions of the pair of the rotating members mesh with each other.

11. The image forming apparatus according to claim 9, wherein the pair of the tooth-like members include a rotating member having a concavo-convex portion in an outer circumferential surface and a rail having a concavo-convex portion meshing with the concavo-convex portion of the rotating member and a guide portion on which a concavo-convex portion meshing with the concavo-convex portion of the rotating member is formed to guide movement of the rotating member, and
the unevenness is formed on the sheet bundle by the movement of the rotating member along the guide portion of the rail while the sheet bundle is nipped between the rotating member and the rail such that the concavo-convex portion of the rotating member and the concavo-convex portion of the rail mesh with each other.

12. The image forming apparatus according to claim 9, wherein the pair of the tooth-like members includes a first tooth-like member having a concavo-convex portion and a second tooth-like member having a concavo-convex portion meshing with the concavo-convex portion of the first tooth-like member,
the pair of the tooth-like members are arranged in a position where the concavo-convex portions mesh with each other and at least one of the pair of the tooth-like members is movable in a contact/separation direction of the concavo-convex portions, and
the unevenness is formed on the sheet bundle by movement of at least one of the pair of the tooth-like members to approach each other while the sheet bundle is nipped between the pair of the tooth-like members such that the concavo-convex portions of the pair of the tooth-like members mesh with each other.

13. The image forming apparatus according to claim 9, wherein the scoring portion includes a concave rotating member having a concave portion and a convex rotating member having a convex portion engaged with the concave portion of the concave rotating member, and
the sheet bundle is scored by engaging and rotating the convex portion of the convex rotating member and the concave portion of the concave rotating member while the sheet bundle is nipped between the concave rotating member and the convex rotating member.

14. The image forming apparatus according to claim 9, wherein the scoring portion includes a concave scoring member having a concave portion and a convex scoring member having a convex portion engaged with the concave portion of the concave scoring member, and
the sheet bundle is scored by movement of at least one of the convex portion of the convex scoring member and the concave portion of the concave scoring member to approach each other while the sheet bundle is nipped between the convex scoring member and the concave scoring member.

15. The image forming apparatus according to claim 9, further comprising:
a sheet conveying portion that conveys the sheet; and
a sheet stacking portion that stacks the sheet conveyed by the sheet conveying portion,
wherein the scoring portion and the binding portion are used to form a score and an unevenness in the sheet bundle stacked on the sheet stacking portion.

16. The image forming apparatus according to claim 9, further comprising:
a sheet conveying portion that conveys the sheet; and
a sheet stacking portion that stacks the sheet conveyed by the sheet conveying portion,
wherein the pair of the tooth-like members are a pair of rotating members including a first rotating member having a concavo-convex portion in an outer circumferential surface and a second rotating member having a concavo-convex portion meshing with the concavo-convex portion of the first rotating member in an outer circumferential surface, and
the scoring portion includes a concave rotating member having a concave portion and a convex rotating member having a convex portion engaged with the concave portion of the concave rotating member, and
the scoring portion and the pair of the tooth-like members move in synchronization with each other along an edge of the sheet bundle stacked on the sheet stacking portion to form a score and an unevenness in the sheet bundle.

17. The image forming apparatus according to claim 9, wherein the scoring portion forms the score between the image formed by the image forming unit and the unevenness formed by the binding portion.
